(19) United States
(12) Patent Application Publication
(10) Pub. No.: US 2007/0239645 A1
(43) Pub. Date: Oct. 11, 2007

(54) Predictive preprocessing of request

(76) Inventors: Ping Du, Shanghai (CN); Ye Tao, Shanghai (CN); Nan N. Li, Shanghai (CN)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/391,894

(22) Filed: Mar. 28, 2006

(51) Int. Cl. G06N 5/00

(52) U.S. Cl. 706/45

(57) ABSTRACT

A method, an article of manufacture, an apparatus, and a system for predictive preprocessing of requests are disclosed herein. In various embodiments, requests may be predicted based on association rules.

### TECHNICAL FIELD

Embodiments of the invention relate generally to the field of data processing, specifically to predictive preprocessing of requests.

### BACKGROUND

Many client/server or browser/server-based applications are serial-task oriented. In these frameworks, a request submitted by a user is processed only when received by the server and, likewise, a subsequent request also is not processed until the server actually receives the subsequent request. For example, resource loading and database sorting are tasks that generally are processed serially.

Problems with the current serial processing framework include response times for any particular request being limited to the amount of time the processor takes to actually process that request. Thus, response times can be decreased only by using a faster processor, for instance. However, this solution does not address the inherent inefficiency with serial-processing frameworks.

### BRIEF DESCRIPTION OF THE DRAWINGS

Embodiments of the present invention will be readily understood by the following detailed description in conjunction with the accompanying drawings. Embodiments of the invention are illustrated by way of example and not by way of limitation in the figures of the accompanying drawings.

FIG. 1 illustrates a method for predictive preprocessing of requests with the teachings of the present invention, in accordance with various embodiments;

FIG. 2 illustrates an apparatus for predictive preprocessing of requests with the teachings of the present invention, in accordance with various embodiments;

FIG. 3 illustrates an article of manufacture for predictive preprocessing of requests with the teachings of the present invention, in accordance with various embodiments; and

FIG. 4 illustrates a system for predictive preprocessing of requests with the teachings of the present invention, in accordance with various embodiments.

### DETAILED DESCRIPTION

Illustrative embodiments of the present invention include but are not limited to methods for preprocessing frameworks, components contributing to the practice of these methods, in part or in whole, and systems endowed with such components.

In the following detailed description, reference is made to the accompanying drawings which form a part hereof and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

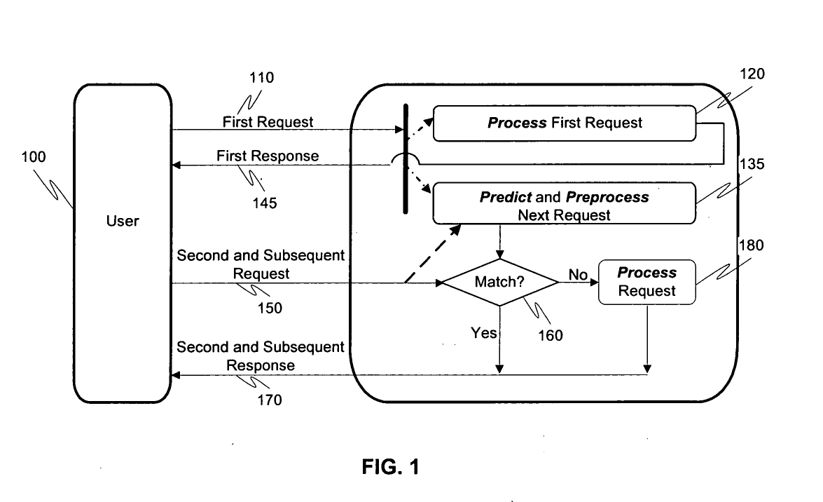

Referring now to FIG. 1, illustrated is a method for predictive preprocessing of requests in accordance with embodiments of the present invention. As shown, in various ones of these embodiments, the method may comprise receiving or retrieving a first request 110 from a user 100, processing 120 first request 110, and returning a response 145 to the user, if appropriate. In various embodiments, the method further comprises predicting and preprocessing one or more next requests 135 of the user 100 prior to receiving or retrieving the user's 100 second request 150.

In various embodiments, the definition of first request 110 may be application dependent, referencing different contexts. In some embodiments, first request 110 may be the first request of a communication session between a requestor client device and a request-servicing server. In other embodiments, first request 110 may be the first request between a requestor client device and a request-servicing server for a time period, regardless of the number of communication sessions during the time period. In other words, the predicted requests (to be described more fully below) are persistent across multiple communication sessions within the time period.

In various embodiments, predicting one or more next requests 135 may be based at least in part on first request 110. Further, predicting one or more next requests 135 may also be based at least in part on one or more association rules associating requests from users with other potential requests.

In various embodiments, an initial collection of association rules may be generated based at least in part on a community request pattern. For example, the initial collection may include an association rule that provides if a request is Request A, then a next request is Request B. This rule may be based, for example, on historical accessing patterns of a general pool of users. Similarly, it is understood that association rules and the assignment of the initial collection of association rules may be further defined based on any number of parameters including, but not limited to, age, gender, time of day, geographical location of user, and so on. Thus, the generation of association rules and the assignment of the initial collection may vary from implementation to implementation.

Further, various embodiments of methods in accordance with the present invention may comprise selecting the one or more association rules from a collection of association rules, based at least in part on the first request 110 and confidence levels of a selected one or more association rules in accurately predicting the next request of the user 100 in view of the first request 110. In various ones of these embodiments, accurate prediction of the next request of the user 100 in view of the first request 110 may comprise selecting one or more association rules having confidence levels greater than a predetermined threshold and/or the unselected ones of the collection of association rules. For example, a Request A may be associated with Request B, Request C, and Request D. Still referring to this example, if Request A is followed 50% of the time by Request B, 20% of the time by Request C, and 30% of the time by Request D, then Request B has the highest confidence level of following Request A, given these choices. Thus, if accurate prediction of the next request of the user 100 comprises selecting one or more association rules having confidence levels greater than unselected ones of the collection of association rules, then Request B would be the selected association rule. However, if accurate prediction of the next request of the user 100 in view of the first request 110 comprises selecting one or more association rules having confidence levels greater than a predetermined threshold, and there is a hypothetical threshold of 30% confidence, then both Request B and Request D would be selected.

In various embodiments, an accumulated access pattern of the user 100 and/or the collection of association rules may be updated, based at least in part on a first request 110 and subsequent requests. In various ones of these embodiments, updating the access pattern of the user 100 and/or the collection of association rules may be performed to adjust parameters and thresholds. This updating may be performed to increase accuracy of the predicted next requests of the user 100.

Still further, in some embodiments, predicting one or more next requests 135 of the user 100 may comprise one or more of generating a new predicted next request, modifying a previously generated predicted next request, and invalidating a previously generated predicted next request.

In various embodiments, a predicted request is preprocessed 135. In various embodiments and/or applications, preprocessing may be complete, having the processing results ready for use, e.g., pre-generating a new web page to be served: In other embodiments and/or applications, preprocessing may be partial, e.g., the web page may be partially generated and/or ready, or a script may be pre-compiled but not executed.

In some embodiments, the method may further comprise receiving or retrieving a second request 150 from a user 100 following the receiving or retrieving of the first request 110 In various ones of these embodiments, a second request 150 may immediately follow a first request 110, i.e., where there are no intervening requests, or the second request may follow after one or more intervening requests have been made. Thus, it is not necessary that the second request 150 have any temporal or sequential relationship with the first request 110 and in fact may be far removed from the first request 110.

In some embodiments, the method may comprise comparing 160 remaining valid one(s) of the predicted one or more next requests to the second request if at least one of the one or more predicted next requests remains a valid prediction. In these embodiments, if one of the remaining valid one(s) of the one or more predicted next request matches the second request, the method may further comprise committing effect resulting from the processing of the matching predicted next request, optionally returning a response 170 to the second request, if applicable, if the predicted request was fully preprocessed. On the other hand, if the matching predicted request was merely partially processed, the method may further comprise completing processing of the matching predicted next request. Still further, if there is no matching predicted next request, second request 150 may be processed 180 as first request 110. Similarly, one or more next requests may be predicted 135, based at least in part on second request 150, and one or more association rules, as earlier described.

The method continues with additional subsequent requests 150.

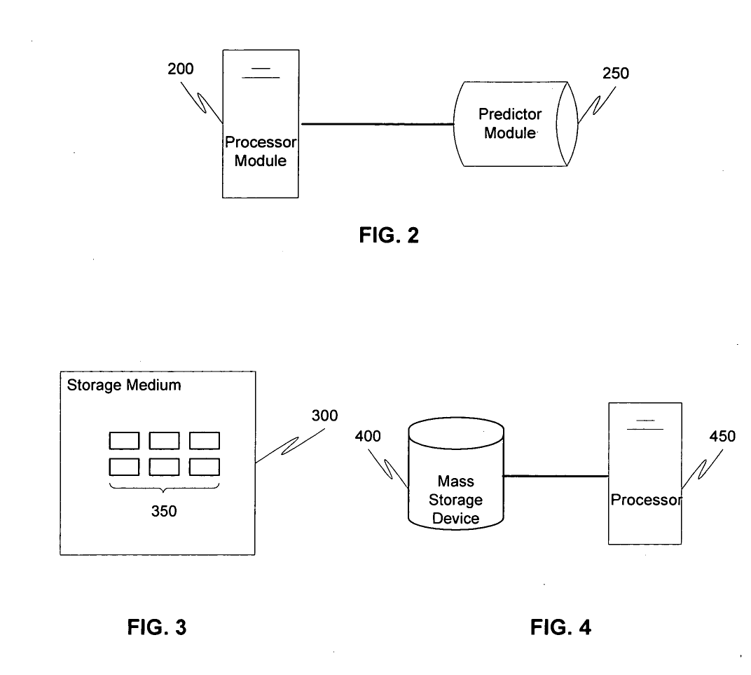

Referring now to FIG. 2, illustrated is an apparatus for predictive preprocessing of requests in accordance with various embodiments of the present invention. As shown, in these embodiments, the apparatus may comprise a processor module 200 and a predictor module 250. In various ones of these embodiments, processor module 200 may be adapted to receive or retrieve requests from a user. Processor module 200 may also be adapted to process the first request, and any subsequent requests not matching a predicted request. Processor module 200 may be further adapted to preprocess at least in part one or more predicted next requests prior to receiving or retrieving the user's next request. Still further, in various embodiments, processor module 200 may be adapted to compare remaining valid one(s) of the predicted one or more next requests to each subsequent request if at least one of the one or more predicted next requests remains a valid prediction. In various ones of these embodiments, if one of the remaining valid one(s) of the one or more predicted next requests matches a subsequent request, processor module 200 may be adapted to commit effect resulting from the preprocessing of the matching predicted next request, if the matching predicted next request was fully preprocessed. In various ones of these embodiments, if one of the remaining valid one(s) of the one or more predicted next requests matches a subsequent request, processor module 200 may be adapted to complete processing the matching predicted next request if the matching predicted next request was only partially preprocessed, prior to committing effect resulting from the processing of the matching predicted next request.

Still referring to various embodiments of processor modules 200 in accordance with the present invention, processor module 200 may be adapted to generate and/or assign an initial collection of association rules based at least in part on a community request pattern. In other embodiments, the processor module 200 may be adapted to update an accumulated access pattern of the user and/or the collection of association rules, based at least in part on the first and subsequent requests.

In some embodiments, predictor module 250 may be variously adapted. For example, predictor module 250 may be adapted to select one or more association rules from a collection of association rules, when making a prediction based at least in part on one or more requests and confidence levels of the selected one or more association rules in accurately predicting the next request of the user in view of the one or more requests, the selected one or more association rules having confidence levels greater than a predetermined threshold, and/or the unselected ones of the collection of association rules. In some embodiments still in accordance with the present invention, predictor module 250 may be variously adapted to perform one or more of the following: generate a new predicted next request, modify a previously generated predicted next request, and invalidate a previously generated predicted next request.

Referring now to FIG. 3, illustrated is an article of manufacture for predictive preprocessing of requests in accordance with various embodiments of the present invention. As shown, an article of manufacture for predicting and preprocessing requests may comprise a storage medium 300 and a plurality of programming instructions 350 stored in the storage medium 300. In some embodiments, an article of manufacture for predicting and preprocessing requests may further comprise one or more initial collections of association rules based at least in part on a community request pattern (not shown).

Regarding the plurality of programming instructions 350 stored in the storage medium 300, in various embodiments, programming instructions 350 may be adapted to program an apparatus to enable the apparatus to receive or retrieve a first request from a user, process the first request, return a response to the first request, if appropriate, predict one or more next requests of the user, and, prior to receipt or retrieval of the user's next request, preprocess at least in part the one or more predicted next request. In various ones of these embodiments, prediction of the one or more next request of the user may be based at least in part on the first request and one or more association rules associating request from users with other potential requests.

Regarding articles of manufacture in accordance with various embodiments of the present invention, the plurality of programming instructions 350 may be further adapted to program an apparatus to enable the apparatus to receive or retrieve a second request from the user following receipt or retrieval of a first request. Further, programming instructions 350 may be adapted to program an apparatus to enable the apparatus to compare remaining valid one(s) of the predicted one or more next requests to the second request if at least one of the one or more predicted next requests remains a valid prediction, and if one of the remaining valid one(s) of the one or more predicted next requests matches the second request, committing effect resulting from the pre-processing of the matching predicted next request, if the matching predicted next request was fully pre-processed. In various embodiments, programming instructions 350 may be further adapted to complete processing the matching predicted next request if the matching predicted next request was only partially preprocessed, prior to committing effect resulting from the processing of the matching predicted next request.

Referring now to FIG. 4, illustrated is a system for predictive preprocessing of requests in accordance with various embodiments of the present invention. As shown, in these embodiments the system may comprise one or more mass storage devices 400 and one or more processors 450 coupled to the mass storage devices. In various ones of these embodiments, processors 450 may be adapted to receive or retrieve requests from a user. Processors 450 may also be adapted to process a first request, and any subsequent request not matching a predicted request. Processors 450 may be further adapted to return a response to the user, if appropriate. In various embodiments, processors 450 may be further adapted to predict one or more next requests based at least in part on a first request and one or more association rules associating requests from users with other potential requests. Still further, in various embodiments, processors 450 may be further adapted to preprocess at least part of the one or more predicted next requests prior to receipt or retrieval of the user's next request.

Processors 450 may be further variously adapted. For example, processors 450 may be adapted to generate an initial collection of association rules based at least in part on a community request pattern. As described earlier, association rules may be based, for example, on historical accessing patterns of a general pool of users. Similarly, association rules and the assignment of the initial collection of association rules may be further defined based on any number of parameters. Thus, the generation of association rules and the assignment of the initial collection may vary from implementation to implementation.

In addition, in various embodiments, processors 450 may be adapted to select the one or more association rules from a collection of association rules. In these embodiments, the selecting of association rules may be based at least in part on the first request and confidence levels of the selected one or more association rules in accurately predicting the next request of the user in view of the first request, the selected one or more association rules having confidence levels greater than a predetermined threshold, and/or the unselected ones of the collection of association rules.

In some embodiments, processors 450 may be further adapted to update an accumulated access pattern of the user and/or the collection of association rules, based at least in part on the first request and subsequent requests. In various ones of these embodiments, updating of the access pattern of the user and/or the collection of association rules may be performed to adjust parameters and thresholds to increase accuracy of the predictions, for example.

In yet another embodiment, processors 450 may be adapted to perform one or more of the following: generate a new predicted next request, modify a previously generated predicted next request, and invalidate a previously generated predicted next request.

In various embodiments, processors 450 may be adapted to preprocess a predicted request. As described earlier, in various embodiments and/or applications, preprocessing may be complete, having the processing results ready for use, e.g., pre-generating a new web page to be served. In other embodiments and/or applications, preprocessing may be partial, e.g., the web page may be partially generated and/or ready, or a script may be pre-compiled but not yet executed.

Still referring to processors 450, in some embodiments processors 450 may be further adapted to receive or retrieve a second request from a user following the receipt or retrieval of the first request. In various embodiments, a second request may immediately follow a first request, i.e., where there are no intervening requests, or the second request may follow after one or more intervening requests have been made. Thus, it is not necessary that the second request have any temporal or sequential relationship with the first request and in fact may be far removed from the first request.

Further, in some embodiments, processors 450 may be adapted to compare remaining valid one(s) of the predicted one or more next requests to each subsequent request if at least one of the one or more predicted next requests remains a valid prediction. In various ones of these embodiments, if one of the remaining valid one(s) of the one or more predicted next request matches the second request, processors 450 may be adapted to commit the effect resulting from the preprocessing of the matching predicted next request, if the matching predicted next request was fully preprocessed, and optionally returning a response to the second request, if applicable. On the other hand, if the matching predicted request was merely partially processed, processors 450 may be adapted to complete processing of the matching predicted next request. Still further, if there is no matching predicted next request, processors 450 may be adapted to process a second request as first request. Similarly, processors 450 may be adapted to predict one or more next requests, based at least in part on second request, and one or more association rules, as earlier described.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A method, comprising:
receiving or retrieving a first request from a user;
processing the first request;
predicting one or more next requests of the user based at least in part on the first request and one or more association rules associating requests from users; and
prior to receiving or retrieving the user's next request, preprocessing at least in part the one or more predicted next requests.

2. The method of claim 1, further comprising:
receiving or retrieving a second request from the user following said receiving or retrieving of the first request;
comparing remaining valid one(s) of the predicted one or more next requests to the second request if at least one of the one or more predicted next requests remains a valid prediction; and
if one of the remaining valid one(s) of the one or more predicted next requests matches the second request, completing processing the matching predicted next request if the matching predicted next request was only partially preprocessed, and committing effect resulting from the processing of the matching predicted next request.

3. The method of claim 2, wherein the second request is received or retrieved immediately following the first request.

4. The method of claim 1, further comprising selecting the one or more association rules from a collection of association rules, based at least in part on the first request and confidence levels of the selected one or more association rules in accurately predicting the next request of the user in view of the first request, the selected one or more association rules having confidence levels greater than a predetermined threshold, and/or the unselected ones of the collection of association rules.

5. The method of claim 4, further comprising updating an accumulated access pattern of the user and/or the collection of association rules, based at least in part on the first request.

6. The method of claim 1, further comprising generating an initial collection of association rules based at least in part on a community request pattern.

7. The method of claim 1, wherein said predicting comprises one or more of:
(a) generating a new predicted next request;
(b) modifying a previously generated predicted next request; and
(c) invalidating a previously generated predicted next request.

8. An article of manufacture, comprising
a storage medium; and
a plurality of programming instructions stored in the storage medium adapted to program an apparatus to enable the apparatus to:
receive or retrieve a first request from a user;
process the first request;
predict one or more next requests of the user based at least in part on the first request and one or more association rules associating requests from users; and
prior to receipt or retrieval of the user's next request, preprocess at least in part the one or more predicted next requests.

9. The article of manufacture of claim 8, wherein the programming instructions are further adapted to program the apparatus to enable the apparatus to:
receive or retrieve a second request from the user following said receipt or retrieval of the first request;
compare remaining valid one(s) of the predicted one or more next requests to the second request if at least one of the one or more predicted next requests remains a valid prediction; and
if one of the remaining valid one(s) of the one or more predicted next requests matches the second request, complete processing the matching predicted next request if the matching predicted next request was only partially preprocessed, and commit effect resulting from the processing of the matching predicted next request.

10. The article of manufacture of claim 8, further comprising an initial collection of association rules based at least in part on a community request pattern.

11. An apparatus, comprising:
a processor module adapted to receive or retrieve a first request from a user and process the request, the processor module further adapted to preprocess at least in part one or more predicted next requests prior to receiving or retrieving the user's next request; and
a predictor module coupled to the processor and adapted to predict one or more next requests of the user based at least in part on the first request and one or more association rules associating requests from users.

12. The apparatus of claim 11, wherein the processor module is further adapted to compare remaining valid one(s) of the predicted one or more next requests to a second request if at least one of the one or more predicted next requests remains a valid prediction, and if one of the remaining valid one(s) of the one or more predicted next requests matches the second request, complete processing the matching predicted next request if the matching predicted next request was only partially preprocessed, and committing effect resulting from the processing of the matching predicted next request.

13. The apparatus of claim 11, wherein the processor module is adapted to generate an initial collection of association rules based at least in part on a community request pattern.

14. The apparatus of claim 11, wherein the processor module is adapted to update an accumulated access pattern of the user and/or the collection of association rules, based at least in part on the first request.

15. The apparatus of claim 11, wherein the predictor module is further adapted to select the one or more association rules from a collection of association rules, based at least in part on the first request and confidence levels of the selected one or more association rules in accurately predicting the next request of the user in view of the first request, the selected one or more association rules having confidence levels greater than a predetermined threshold, and/or the unselected ones of the collection of association rules.

16. The apparatus of claim 11, wherein the predictor module is further adapted to perform one or more of:
(a) generate a new predicted next request;
(b) modify a previously generated predicted next request; and
(c) invalidate a previously generated predicted next request.

17. A system comprising
one or more mass storage devices; and
one or more processors coupled to the mass storage devices and adapted to:
receive or retrieve a first request from a user;
process the first request;
predict one or more next requests of the user based at least in part on the first request and one or more association rules associating requests from users; and
preprocess at least in part the one or more predicted next requests prior to receipt or retrieval of the user's next request.

18. The system of claim 17, wherein one or more of the processors are further adapted to:
receive or retrieve a second request from the user following said receipt or retrieval of the first request;
compare remaining valid one(s) of the predicted one or more next requests to the second request if at least one of the one or more predicted next requests remains a valid prediction; and
if one of the remaining valid one(s) of the one or more predicted next requests matches the second request, complete processing the matching predicted next request if the matching predicted next request was only partially preprocessed, and commit effect resulting from the processing of the matching predicted next request.

19. The system of claim 17, wherein one or more of the processors are further adapted to select the one or more association rules from a collection of association rules, based at least in part on the first request and confidence levels of the selected one or more association rules in accurately predicting the next request of the user in view of the first request, the selected one or more association rules having confidence levels greater than a predetermined threshold, and/or the unselected ones of the collection of association rules.

20. The system of claim 19, wherein one or more of the processors are further adapted to update an accumulated access pattern of the user and/or the collection of association rules, based at least in part on the first request.

21. The system of claim 17, wherein one or more of the processors are further adapted to generate an initial collection of association rules based at least in part on a community request pattern.

22. The system of claim 17, wherein one or more of the processors are further adapted to perform one or more of the following:
(a) generate a new predicted next request;
(b) modify a previously generated predicted next request; and
(c) invalidate a previously generated predicted next request.
